(19) United States
(12) Patent Application Publication
(10) Pub. No.: US 2019/0220739 A1
(43) Pub. Date: Jul. 18, 2019

(54) NEURAL NETWORK COMPUTING DEVICE AND OPERATION METHOD THEREOF

(71) Applicant: ELECTRONICS AND TELECOMMUNICATIONS RESEARCH INSTITUTE, Daejeon (KR)

(72) Inventors: Young-Su KWON, Daejeon (KR); Hyun Mi KIM, Daejeon (KR); Jeongmin YANG, Busan (KR)

(21) Appl. No.: 16/225,729

(22) Filed: Dec. 19, 2018

(30) Foreign Application Priority Data
Jan. 16, 2018 (KR) 10-2018-0005719
May 11, 2018 (KR) 10-2018-0054392

(51) Int. Cl. G06N 3/08; G06F 7/523

(52) U.S. Cl. CPC G06N 3/08; G06F 7/523

(57) ABSTRACT

Provided is a neural network computing device including a neural network memory configured to store input data, a kernel memory configured to store kernel data corresponding to the input data, a kernel data controller configured to determine whether or not a first part of the kernel data matches a predetermined bit string, and if the first part matches the predetermined bit string, configured to generate a plurality of specific data based on a second part of the kernel data, and a neural core configured to perform a first operation between one of the plurality of specific data and the input data.

### CROSS-REFERENCE TO RELATED APPLICATIONS

This U.S. non-provisional patent application claims priority under 35 U.S.C. § 119 of Korean Patent Application Nos. 10-2018-0005719, filed on Jan. 16, 2018, and 10-2018-0054392, filed on May 11, 2018, the entire contents of which are hereby incorporated by reference.

### BACKGROUND

The present disclosure herein relates to a neural network computing semiconductor, and more particularly, to a neural network computing device that performs computation of a neural network that requires a large memory size and an operation method thereof.

With the popularization of artificial intelligence services by the 4th industrial revolution, information and communication devices equipped with artificial intelligence computing capabilities are increasing. Neural network computing is performed in various applications such as autonomous navigation, image recognition, and speech recognition. Neural network computing requires a higher level of computing than a typical application processor. Accordingly, there is a need for a technique for implementing a large amount of computing capability required by a Deep Learning Artificial Neural Network by using a small semiconductor.

Semiconductors for neural network computing should perform floating point operations corresponding to 1 and 100 trillion operations per second. For this high-speed operation, a large-capacity memory can be implemented in the semiconductor chip. A method of implementing a large-capacity memory in a chip may be referred to as an on-chip large memory. In the case of an on-chip large memory, an increase in the price of a semiconductor chip, a decrease in productivity due to a decrease in the proportion of a semiconductor die, and a decrease in operation speed due to a decrease in operating frequency may occur. In particular, it is difficult to add or remove memory capacity after implementing on-chip large memory.

### SUMMARY

The present disclosure is to provide a neural network computing device that performs compression and decompression of data to reduce the capacity of on-chip memory in neural network computing and an operation method thereof.

An embodiment of the inventive concept provides a neural network computing device including: a neural network memory configured to store input data; a kernel memory configured to store kernel data corresponding to the input data; a kernel data controller configured to determine whether or not a first part of the kernel data matches a predetermined bit string, and if the first part matches the predetermined bit string, configured to generate a plurality of specific data based on a second part of the kernel data; and a neural core configured to perform a first operation between one of the plurality of specific data and the input data.

In an embodiment, the kernel data may be in a floating point format, and the first part may include an exponent portion of the kernel data, and the second part may include a mantissa portion of the kernel data.

In an embodiment, the predetermined bit string may represent whether the kernel data is infinite or not a number (NaN).

In an embodiment, the number of the specific data may correspond to a value represented by the second part.

In an embodiment, the specific data may represent 0.

In an embodiment, if the first part does not match the predetermined bit string, the kernel data controller may transfer the kernel data to the neural core, and the neural core may perform a second operation between the input data and the kernel data.

In an embodiment, the first operation and the second operation may be multiplication operations.

In an embodiment, the kernel memory may store first kernel data and second kernel data, wherein when the first part of the first kernel data may match the predetermined bit string, the kernel data controller may generate a plurality of specific data based on the second part of the first kernel data and the second kernel data.

In an embodiment, the first and second kernel data may be in a floating point format, wherein the first part of the first kernel data may include an exponent portion of the first kernel data and a most significant bit of a mantissa portion of the first kernel data, wherein the second part of the first kernel data may include remaining bits except the most significant bit of the mantissa portion.

In an embodiment, the number of the specific data may correspond to a value represented by a combination of a bit string of the second part of the first kernel data and a bit string of the second kernel data.

In an embodiment of the inventive concept, provided is a method of operating a neural network computing device including a kernel data controller and a neural core, the method including: determining, by the kernel data controller, whether a first part of kernel data corresponding to input data matches a predetermined bit string; generating, by the kernel data controller, a plurality of specific data based on a second part of the kernel data when the first part matches the predetermined bit string; providing, by the kernel data controller, one of the plurality of specific data to the neural core; and performing, by the neural core, a first operation between the input data and the specific data.

In an embodiment, the kernel data may be in a floating point format, and the first part may include an exponent portion of the kernel data, and the second part may include a mantissa portion of the kernel data.

In an embodiment, the predetermined bit string may represent whether the kernel data is infinite or not a number (NaN).

In an embodiment, the generating of the plurality of specific data may include generating, by the kernel data controller, the specific data by a number corresponding to a value represented by the second part.

In an embodiment, the specific data may represent 0.

In an embodiment, the method may further include: if the first part does not match the predetermined bit string, transferring, by the kernel data controller, the kernel data to the neural core; and performing, by the neural core, a second operation between the input data and the kernel data.

In an embodiment, the first operation and the second operation may be multiplication operations.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a block diagram showing a schematic operation of a neural network computing device according to an embodiment of the present invention;

FIG. 2 is a block diagram showing one example of a neural network computing device of FIG. 1;

FIG. 3 is a view showing an example of the operation of the neural network computing device of FIG. 2;

FIG. 4 is a view showing an example of kernel data according to an embodiment of the present invention;

FIGS. 5A and 5B are views showing an example of the operation of the neural network computing device of FIG. 3 to process kernel data;

FIG. 6 is a flowchart showing an example of the operation of the neural network computing device of FIG. 3;

FIG. 7 is a view showing another example of the operation of the neural network computing device of FIG. 2;

FIG. 8 is a view showing an example of a first kernel data and second data processed by the kernel neural network computing device of FIG. 7;

FIG. 9 is a view showing an example of the operation of the neural network computing device of FIG. 7 to process first kernel data and second kernel data; and

FIG. 10 is a flowchart showing an example of the operation of the neural network computing device of FIG. 7.

### DETAILED DESCRIPTION

Hereinafter, embodiments of the inventive concept will be described in more detail with reference to the accompanying drawings. In the description below, details such as detailed configurations and structures are simply provided to help overall understanding. Therefore, without departing from the technical idea and scope of the inventive concept, modifications on embodiments described in this specification may be performed by those skilled in the art. Furthermore, descriptions of well-known functions and structures are omitted for clarity and conciseness. The terms used herein are defined in consideration of functions of the inventive concept and are not limited to specific functions. The definition of terms may be determined based on the details in description.

Modules in drawings or detailed description below may be shown in the drawings or may be connected to another component other than components described in detailed description. Each of connections between modules or components may be direct or indirect. Each of connections between modules or components may be a connection by communication or a physical access.

Components described with reference to terms such as parts, units, modules, and layers used in detailed description may be implemented in software, hardware, or a combination thereof. Exemplarily, software may be machine code, firmware, embedded code, and application software. For example, hardware may include an electrical circuit, an electronic circuit, a processor, a computer, an integrated circuit, integrated circuit cores, a pressure sensor, an inertial sensor, microelectromechanical systems (MEMS), a passive device, or a combination thereof.

Unless otherwise defined, all terms including technical or scientific meanings used in the specification have meanings understood by those skilled in the art. In general, the terms defined in the dictionary are interpreted to have the same meanings as contextual meanings and unless they are clearly defined in the specification, are not to be interpreted to have ideal or excessively formal meanings.

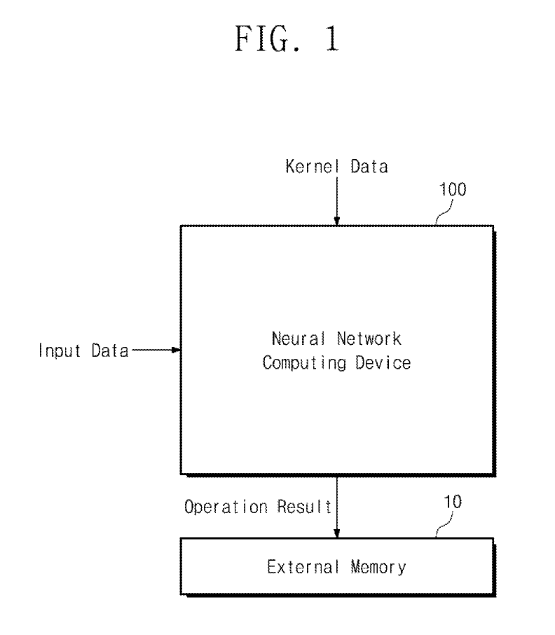

FIG. 1 is a block diagram showing a schematic operation of a neural network computing device according to an embodiment of the present invention. Referring to FIG. 1, a neural network computing device 100 may receive input data and kernel data. The input data may be data subject to inference from a neural network computing device. The kernel data may be data used for inference of input data. For example, the input data may be pixel data of an image, and the kernel data may be a shape represented by the image based on the pixel data or a weight used to infer the object.

The kernel data may be data obtained through a learning process based on a neural network. That is, a weight may be obtained through a learning process, and the obtained weight may be kernel data.

The neural network computing device 100 may perform an operation of input data and kernel data to output the operation result. An inference of the input data can be made based on the operation result of the input data and the kernel data. For example, when image recognition is performed based on a Convolutional Neural Network (CNN), the neural network computing device 100 may receive image data as input data and receive weights as kernel data. The neural network computing device 100 may perform a convolutional operation on the image data and the weight, and may output the operation result. The shape or object represented by the image data may be inferred based on the result of the convolutional operation on the image data and the weight.

The external memory 10 may store the operation result outputted from the neural network computing device 100. An inference of the input data can be made based on the operation result stored in the external memory 10.

For example, the kernel data provided to the neural network computing device 100 may be in a compressed form. When there are consecutive kernel data representing the same value, a plurality of kernel data can be compressed into one kernel data. For example, in the case where kernel data representing ‘0’ continuously exists, kernel data representing ‘0’ continuously can be compressed into one kernel data. In this case, the value represented by the compressed kernel data may be the number of consecutive kernel data.

When the kernel data is received, the neural network computing device 100 may determine whether the kernel data is compressed data according to a predetermined condition. When compressed kernel data is received, the neural network computing device 100 may generate a plurality of specific data from the compressed kernel data. The specific data may be data representing the same value as a plurality of kernel data before being compressed. In other words, by generating a plurality of specific data, the compressed kernel data can be decompressed. Information on the specific data may be stored in advance in the neural network computing device 100. For example, the neural network computing device 100 may store information that specific data is data representing ‘0’, in advance.

The neural network computing device 100 may perform operations between the generated specific data and the input data. When compressed kernel data is received, the neural network computing device 100 may generate a plurality of specific data from the compressed kernel data. Accordingly, the neural network computing device 100 can perform operations between uncompressed kernel data and input data.

For example, uncompressed kernel data may include one weight, and the compressed kernel data may include a plurality of weights. Thus, the uncompressed kernel data may represent one weight value, and the compressed kernel data may represent the number of weights representing the same value. The specific data generated from the compressed kernel data may correspond to one weight and the neural network computing device 100 may generate specific data by the number of weights represented by the compressed kernel data.

In this way, since the kernel data provided to the neural network computing device 100 can include a plurality of kernel data, the total capacity of the provided kernel data can be reduced. If the total capacity of the kernel data is reduced, the memory capacity within the neural network computing device 100 for storing kernel data may be reduced. Thus, the chip area of the neural network computing device 100 can be reduced, and the power consumption can be reduced due to the reduction of the memory size.

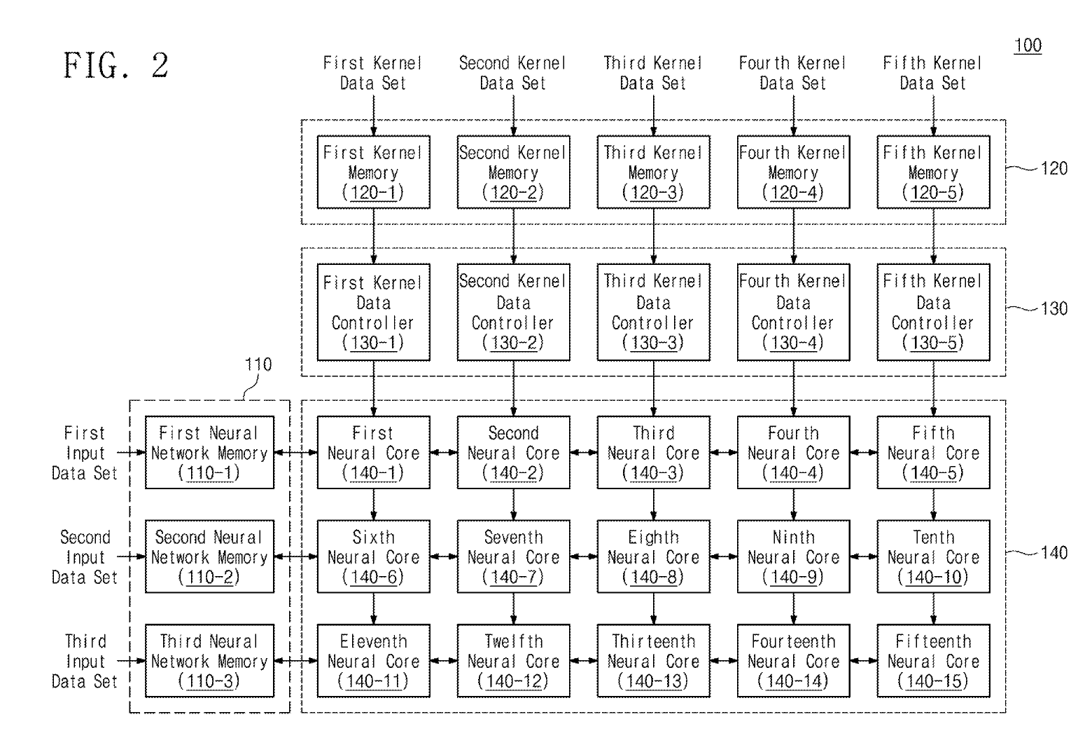

FIG. 2 is a block diagram showing one example of a neural network computing device of FIG. 1. Referring to FIG. 2, a neural network computing device 100 may include a neural network memory 110, a kernel memory 120, a kernel data controller 130, and a neural core 140. The neural network memory 110 may include first to third neural network memories 130-1 to 130-3. The neural network memory 110 may receive first to third input data sets provided from the outside. The first to third input data sets may each include a plurality of input data. Each of the first to third neural network memories 110-1 to 110-3 may receive and store a corresponding set of input data. For example, the first neural network memory 110-1 may receive and store a first input data set.

The kernel memory 120 may include first to fifth kernel memories 120-1 to 120-5. The kernel memory 120 may receive first to fifth kernel data sets provided from the outside. Each of the first through fifth kernel data sets may include a plurality of kernel data. The kernel data may be compressed kernel data or uncompressed kernel data. Each of the first to fifth kernel memories 120-1 to 120-5 may receive and store a corresponding kernel data set. For example, the first kernel memory 120-1 may receive and store a first kernel data set.

The kernel data controller 130 may include first to fifth kernel data controllers 130-1 to 130-5. Each of the first to fifth kernel data controllers 130-1 to 130-5 may fetch kernel data from the corresponding kernel memory 120 and store the kernel data in a buffer (not shown) in the kernel data controller 130. For example, the kernel data controller 130 may store fetched kernel data in a flip-flop (not shown).

For example, each kernel data controller 130 may determine whether the kernel data is compressed kernel data according to predetermined conditions. For example, the kernel data controller 130 can identify a specific bit string of the fetched kernel data and determine whether or not the kernel data is compressed kernel data based on a specific bit string of the kernel data. If the kernel data is compressed kernel data, the kernel data controller 130 may generate a plurality of specific data based on the bits contained in the kernel data. For example, the kernel data controller 130 may generate specific data by the number of values represented by the bits contained in the kernel data. Information on the specific data to be generated may be stored in advance in the kernel data controller 130. The kernel data controller 130 may decompress kernel data by generating a plurality of specific data. The kernel data controller 130 may sequentially output a plurality of specific data generated according to decompression.

If the bit string of the kernel data is not satisfied with the predetermined condition, the kernel data controller 130 may not generate the specific data. The kernel data controller 130 can output the kernel data fetched from the kernel memory 120 directly to the neural core 140. Accordingly, the kernel data controller 130 can determine whether the kernel data is compressed kernel data, and provide kernel data or specific data to the neural core 140.

The neural core 140 may receive input data from the neural network memory 110 and receive kernel data or specific data from the kernel data controller 130. The neural core 140 may perform an operation between the input data and the kernel data according to the received data or may perform an operation between the input data and the specific data.

The neural core 140 may include first to fifteenth neural cores 140-1 to 140-15. Each of the first to fifteenth neural cores 140-1 to 140-15 may perform an operation between input data and kernel data or may perform an operation between input data and specific data. Each of the first to fifteenth neural cores 140-1 to 140-15 may accumulate the operation results in an internal register (not shown). The cumulative operation result stored in each of the first to fifteenth neural cores 140-1 to 140-15 may be transferred to the neural network memory 110. The result of the operation can be transferred from the neural network memory 110 to the external memory 10.

For example, the input data provided from the neural network memory 110 may be transferred to the neural core 140 through the neural core 140. For example, the input data outputted from the first neural network memory 110-1 is transferred to the first neural core 140-1 and may be transferred to the second neural core 140-2 through the first neural core 140-1. Thus, the input data may be transferred to the fifth neural core 140-5 through the first to fourth neural cores 140-1 to 140-4.

Likewise, kernel data or specific data provided from the kernel data controller 130 may be transferred to the neural core 140 through the neural core 140. For example, the kernel data outputted from the first kernel data controller 130-1 is transferred to the first neural core 140-1 and is transferred to the sixth neural core 140-1 through the first neural core 140-6. Thus, the kernel data can be transferred to the 11th neural core 140-11 through the first and sixth neural cores 140-1 and 140-6.

For example, each neural core 140 may operate based on an internal clock. The neural core 140 may perform operations between the input data and the kernel data provided for each clock cycle. Alternatively, the neural core 140 may perform an operation between input data and specific data provided for each clock cycle. The neural core 140 may accumulate the results of operations performed every clock cycle. The neural core 140 may transfer the result of the accumulation to the neural network memory 110. For example, the neural core 140 may perform multiplication of kernel data with input data provided for each clock cycle, and may add up the multiplication results. The neural core 140 may transfer the accumulated multiplication result to the neural network memory 110.

As shown in FIG. 2, the neural network computing device 100 according to an embodiment of the present invention may be implemented in an array form. Accordingly, the neural network computing device 100 can efficiently perform a large matrix operation on the input data and the kernel data, and the operation time can be shortened.

In addition, since some of the kernel data provided to the neural network computing device 100 may be in a compressed form including information on a plurality of kernel data, the capacity of the kernel data provided to the neural network computing device 100 may be reduced. Accordingly, the neural network computing device 100 can be implemented using a kernel memory 120 having a small capacity. Alternatively, the neural network computing device 100 may store information on more kernel data using kernel memory 120 of the same capacity.

As shown in FIG. 2, the neural network computing device 100 includes three neural network memories 110, five kernel memories 120, five kernel data controllers 130, and fifteen neural cores 140, but the inventive concept is not limited thereto. For example, the neural network computing device 100 may include various numbers of neural network memories 110, kernel memories 120, kernel data controllers 130, and neural cores 140.

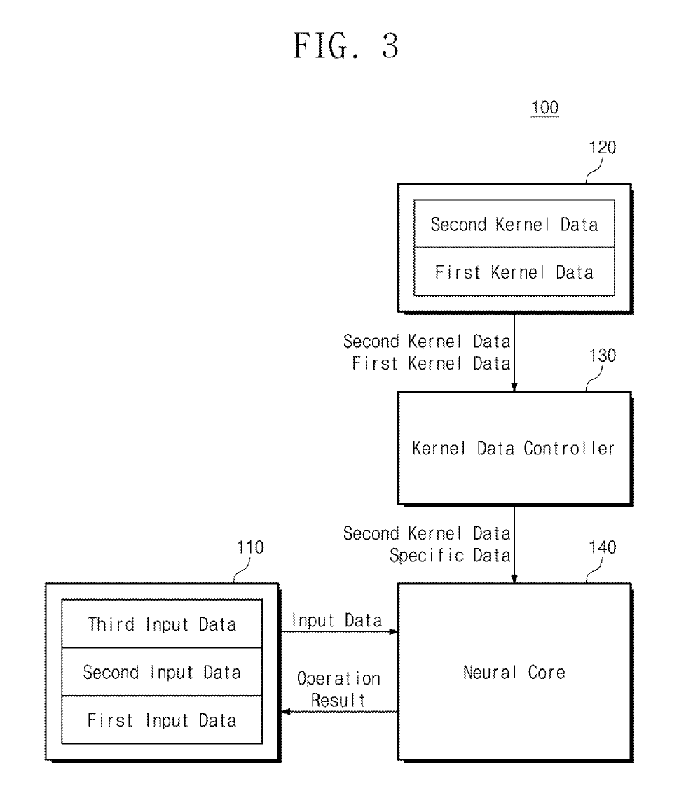

In the following, one embodiment of a neural network computing device 100 is described with reference to FIGS. 3 to 6. For convenience of explanation, it is assumed that the neural network memory 110, the kernel memory 120, the kernel data controller 130, and the neural core 140 shown in the neural network computing device 100 of FIGS. 3 to 6 correspond to one of the plurality of neural network memories 110-1 to 110-3, one of the plurality of kernel memories 120-1 to 120-5, one of the plurality of kernel data controllers 130-1 to 130-5, and one of the plurality of neural cores 140-1 to 140-15 in FIG. 2, respectively.

FIG. 3 is a view showing an example of the operation of the neural network computing device of FIG. 2. Referring to FIG. 3, a neural network computing device 100 may include a neural network memory 110, a kernel memory 120, a kernel data controller 130, and a neural core 140.

The neural network memory 110 may receive and store the first to third input data from the outside. The neural network memory 110 may sequentially output the first to third input data according to a clock cycle. The outputted input data may be provided to the neural core 140.

The kernel memory 120 may receive and store the first and second kernel data from the outside. The first kernel data may be compressed kernel data, and the second kernel data may be uncompressed kernel data. The kernel memory 120 may sequentially output the first and second kernel data according to a clock cycle. The outputted kernel data may be provided to the kernel data controller 130.

The kernel data controller 130 may first receive the first kernel data and determine whether the first kernel data is compressed kernel data. When a specific bit string of the first kernel data matches a predetermined bit string, the kernel data controller 130 can determine the first kernel data as compressed kernel data. In this case, the kernel data controller 130 may generate specific data based on the bits contained in the first kernel data. The kernel data controller 130 may store information on specific data in advance. The kernel data controller 130 may generate specific data by the number of values represented by some bits included in the first kernel data. The kernel data controller 130 generates a plurality of specific data, and outputs specific data one by one every clock cycle.

The first kernel data may be in a form in which two kernel data corresponding to the first and second input data are compressed. Accordingly, the kernel data controller 130 may generate two specific data from the first kernel data. The generated two specific data may be kernel data corresponding to the first and second input data. For example, the two specific data may be a weight corresponding to each of the first and second input data, and the weight corresponding to the first input data may be equal to the weight corresponding to the second input data.

The kernel data controller 130 sequentially outputs two specific data, and then determines whether or not the second kernel data is compressed kernel data. If the specific bit string of the second kernel data does not match the predetermined bit string, the kernel data controller 130 can determine the second kernel data as uncompressed kernel data. The kernel data controller 130 may output the second kernel data to the neural core 140 as it is.

The second kernel data may be kernel data corresponding to the third input data. For example, the second kernel data may be a weight corresponding to the third input data.

The neural core 140 may receive the first input data and the specific data, and may perform an operation between the first input data and the specific data. For example, the neural core 140 may perform a multiplication operation between the first input data and specific data. Similarly, the neural core 140 may perform operations between the second input data and the specific data. The neural core 140 may perform an operation between the third input data and the second kernel data.

The neural core 140 may accumulate and sum sequentially the results of operations performed sequentially. The neural core 140 may transfer the result of the accumulation to the neural network memory 110. The neural network memory 110 may store the operation result and transfer the operation result to the external memory 10. That is, the neural network memory 110 may store various kinds of data as well as input data.

As shown in FIG. 3, the number of kernel data provided to the neural network computing device 100 may be smaller than the number of input data. Accordingly, the neural network computing device 100 can be implemented using a kernel memory 120 having a small capacity. Alternatively, the neural network computing device 100 may store information on more kernel data using kernel memory 120 of the same capacity.

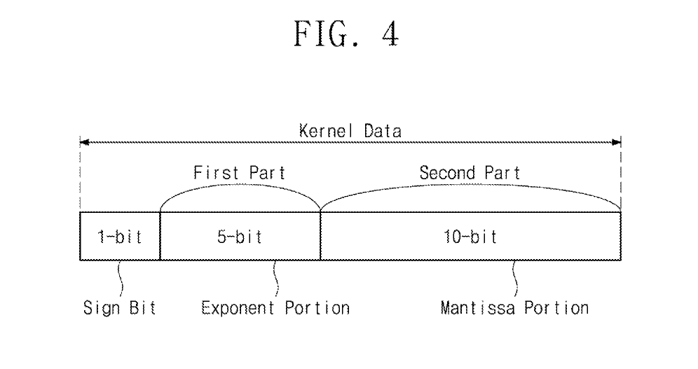

FIG. 4 is a view showing an example of kernel data according to an embodiment of the present invention. Referring to FIG. 4, the kernel data may be in floating point format. The kernel data may include a sign bit, an exponent portion, and a mantissa portion. The sign bit may represent whether the value of the kernel data is negative or positive. For uncompressed kernel data, the exponent portion and the mantissa portion can represent kernel data values. For compressed kernel data, the exponent portion may represent whether the kernel data is in a compressed state, and the mantissa portion may represent the number of kernel data contained in the compressed kernel data.

As shown in FIG. 4, the sign bit, the exponent portion, and the mantissa portion may be 1-bit, 5-bit and 10-bit, respectively. That is, the kernel data of FIG. 4 may be a 16-bit floating point format, but the present invention is not limited thereto.

The kernel data controller 130 may determine whether the first part of the kernel data matches a predetermined bit string. The first part may be the exponent portion of the kernel data. When the first part matches a predetermined bit string, the kernel data controller 130 can determine the kernel data as compressed kernel data. When the first part does not match a predetermined bit string, the kernel data controller 130 can determine the kernel data as uncompressed kernel data.

If the kernel data is determined to be compressed kernel data, the kernel data controller 130 may generate specific data based on the second part. The second part may be the mantissa portion of the kernel data. The kernel data controller 130 may generate specific data by the number of values represented by the bits included in the second part. The generated specific data may be in the same data format as the kernel data. That is, the kernel data controller 130 may generate specific data expressed in a 16-bit floating point format.

If the kernel data is determined to be uncompressed kernel data, the kernel data controller 130 may not generate any specific data. The value represented by uncompressed kernel data can be determined by the sign bit, the exponent portion, and the mantissa portion.

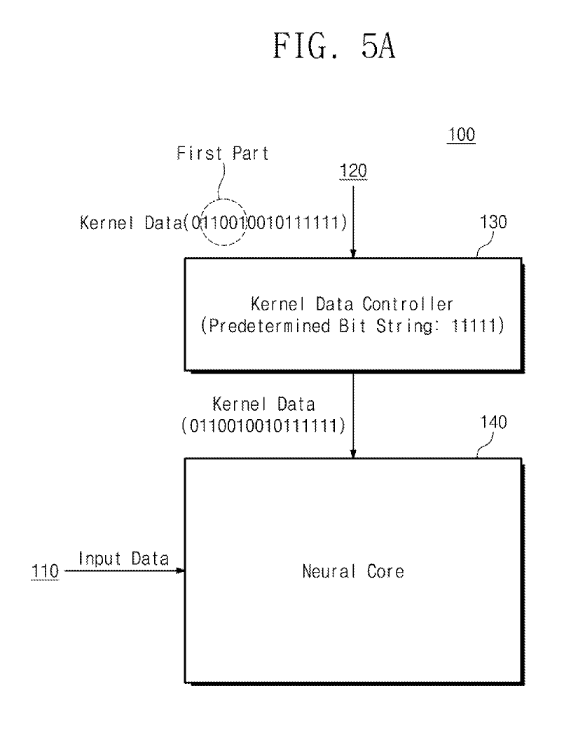

FIGS. 5A and 5B are views showing an example of the operation of the neural network computing device of FIG. 3 to process kernel data. Specifically, FIG. 5A shows an example in which uncompressed kernel data is processed, and FIG. 5B shows an example in which compressed kernel data is processed.

First, referring to FIG. 5A, the kernel data controller 130 may receive kernel data from the kernel memory 120. The bit string of the kernel data may be ‘0110010010111111’. The kernel data controller 130 may compare the first part of the kernel data with a predetermined bit string. The first part of the kernel data may be ‘11001’, and the predetermined bit string may be ‘11111’. In this case, since the first part of the kernel data does not match the predetermined bit string, the kernel data controller 130 can determine the kernel data as uncompressed kernel data. The kernel data controller 130 may output the kernel data to the neural core 140 as it is. The neural core 140 may perform operations between the input data provided from the neural network memory 110 and the kernel data.

Referring to FIG. 5B, the kernel data controller 130 may receive kernel data from the kernel memory 120. The bit string of the kernel data may be ‘0111110000011111’. The kernel data controller 130 may compare the first part of the kernel data with a predetermined bit string. The first part of the kernel data may be ‘11111’, and the predetermined bit string may be ‘11111’. In this case, since the first part of the kernel data matches the predetermined bit string, the kernel data controller 130 can determine the kernel data as compressed kernel data.

The kernel data controller 130 may generate specific data by the number of values represented by the second part of the kernel data. Since the second part of the kernel data is ‘0000011111’, which represents ‘31’, the kernel data controller 130 can generate 31 specific data. For example, the kernel data controller 130 may generate data representing 31 consecutive ‘0’s. The kernel data controller 130 may generate 31 16-bits ‘0000000000000000’ as specific data representing ‘0’ to match the number of bits with the kernel data. That is, the kernel data controller 130 may generate 31 16-bit specific data.

The information (for example, a 16-bit floating point format in which certain data is represented as ‘0’) on the specific data may be stored in advance in the kernel data controller 130. The kernel data controller 130 may sequentially output 31 specific data to the neural core 140. The neural core 140 receives 31 input data from the neural network memory 110 and 31 specific data from the kernel data controller 130. Accordingly, the neural core 140 can perform an operation between the input data 31 and the specific data.

As shown in FIGS. 5A and 5B, the predetermined bit string may be ‘11111’. If the exponent portion of kernel data in the 16-bit floating point format is ‘11111’, this may represent infinity or not a number (NaN). In the learning process of the neural network, infinite or non-numeric kernel data is not generated, so that the case where the exponent portion of the kernel data is ‘11111’ may not occur. Therefore, the exponent portion of ‘11111’ can be used to represent compressed kernel data.

Also, in the learning process of the neural network, a lot of ‘0’ kernel data can be generated. Accordingly, when kernel data of ‘0’ continuously appearing is compressed, the capacity of kernel data provided to the neural network computing device 100 can be greatly reduced. Therefore, the specific data generated by the kernel data controller 130 may be data representing ‘0’. In order to match the data format of the kernel data with the specific data, the kernel data controller 130 may generate ‘0000000000000000’ expressed in 16-bit floating point format.

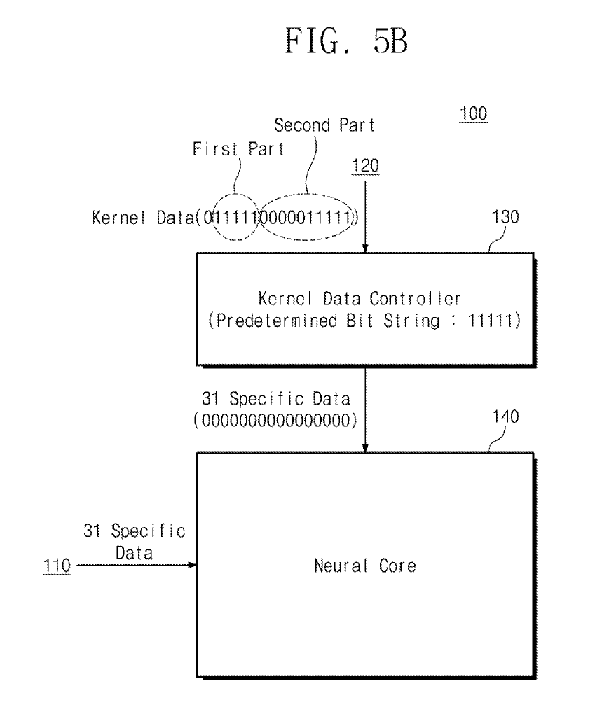

FIG. 6 is a flowchart showing an example of the operation of the neural network computing device of FIG. 3. Referring to FIGS. 3 to 6, in operation S101, the neural network computing device 100 may determine whether the first part of the kernel data matches a predetermined bit string. As shown in FIG. 4, the kernel data may be in floating point format, and the first part of the kernel data may include the exponent portion of the kernel data. The predetermined bit string may be a bit string representing that the kernel data is infinite or is not a number. As shown in FIGS. 5A and 5B, all bits included in the predetermined bit string may be ‘1’.

When the first part of the kernel data matches the predetermined bit string, in operation S102, the neural network computing device 100 can generate specific data based on the second part of the kernel data. The neural network computing device 100 may generate the specific data by the number corresponding to the value represented by the bits included in the second part. As shown in FIG. 5B, the neural network computing device 100 may generate specific data representing ‘0’ by the number corresponding to the value represented by the second part. For example, if the value represented by the second part is n, the neural network computing device 100 may generate n specific data.

In operation S103, the neural network computing device 100 may perform an operation between input data and specific data. For example, the neural network computing device 100 may perform a multiplication operation between input data and specific data. When n specific data is generated, the neural network computing device 100 may perform n multiplication operations between n input data and n specific data.

If the first part of the kernel data does not match the predetermined bit string, in operation S104, the neural network computing device 100 may perform operations between input data and kernel data.

As described above, the neural network computing device 100 according to the embodiment of the present invention can receive compressed kernel data from the outside. Accordingly, the neural network computing device 100 can quickly receive a large amount of kernel data from the outside. Also, the capacity of the received kernel data may be reduced according to the compressed kernel data. Accordingly, the capacity of the kernel memory 120 storing the kernel data can be reduced. When the size of the kernel memory 120 is reduced according to the capacity reduction of the kernel memory 120, the chip area of the neural network computing device 100 may be reduced and the power required to operate the neural network computing device 100 may be reduced.

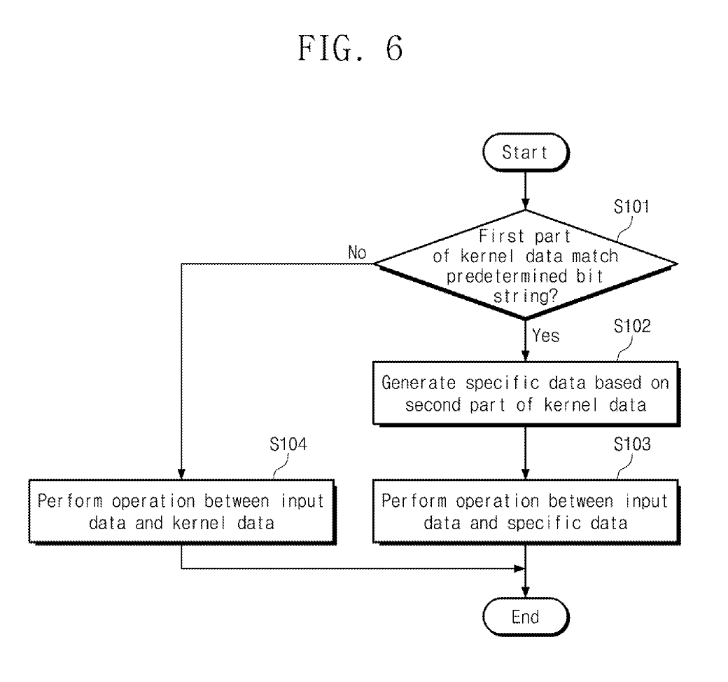

Hereinafter, another example of the operation of the neural network computing device 100 will be described with reference to FIGS. 7 to 10. For convenience of explanation, it is assumed that the neural network memory 110a, the kernel memory 120a, the kernel data controller 130a, and the neural core 140a shown in the neural network computing device 100a of FIGS. 7 to 10 correspond to one of the plurality of neural network memories 110-1 to 110-3, one of the plurality of kernel memories 120-1 to 120-5, one of the plurality of kernel data controllers 130-1 to 130-5, and one of the plurality of neural cores 140-1 to 140-15 in FIG. 2, respectively.

FIG. 7 is a view showing another example of the operation of the neural network computing device of FIG. 2. Referring to FIG. 7, a neural network computing device 100a may include a neural network memory 110a, a kernel memory 120a, a kernel data controller 130a, and a neural core 140a.

The neural network memory 110a may receive and store the first to n-th input data from the outside. The neural network memory 110a may sequentially output the first to n-th input data according to a clock cycle. The outputted input data may be provided to the neural core 140a.

The kernel memory 120a may receive and store the first and second kernel data from the outside. The first and second kernel data may be compressed kernel data. The kernel memory 120a may sequentially output the first and second kernel data according to a clock cycle. The outputted kernel data may be provided to the kernel data controller 130a.

The kernel data controller 130a may receive the first kernel data and may determine whether a specific bit string of the first kernel data matches a predetermined bit string. When a specific bit string of the first kernel data matches a predetermined bit string, the kernel data controller 130a can determine the first kernel data and the second kernel data as compressed kernel data. That is, the kernel data controller 130a can determine the first kernel data and the second kernel data received immediately thereafter as compressed kernel data. In this case, the kernel data controller 130a may generate specific data based on the bits included in the first kernel data and the second kernel data. The kernel data controller 130a may generate specific data by the number of values represented by a combination of some bits included in the first kernel data and bits included in the second kernel data. The kernel data controller 130a generates a plurality of specific data, and outputs specific data one by one every clock cycle.

The first kernel data and the second kernel data may be in the form of compressed n-th kernel data corresponding to the first to n-th input data. Accordingly, the kernel data controller 130a may generate n specific data from the first and second kernel data. The generated n specific data may be kernel data corresponding to the first to n-th input data.

The neural core 140a may receive the first input data and the specific data, and may perform an operation between the first input data and the specific data. Similarly, the neural core 140a can perform operations between the second to n-th input data and specific data. The neural core 140a may accumulate and sum sequentially the results of operations performed sequentially. The neural core 140a may transfer the result of the accumulation to the neural network memory 110a.

As shown in FIG. 7, specific data can be generated based on the first and second kernel data, but the present invention is not limited thereto. For example, specific data may be generated based on more than two kernel data.

As described above, when the kernel data corresponding to a plurality of input data is compressed using the first and second kernel data, more kernel data can be compressed than performing compression using one kernel data. For example, if the number of consecutive weights with the same value is greater than a value that can be represented using one kernel data, the values of consecutive weights can be compressed using the two kernel data. Therefore, when compression is performed using a plurality of kernel data, the compression rate of the kernel data can be improved and the capacity of the kernel data provided to the neural network computing device 100a can be further reduced.

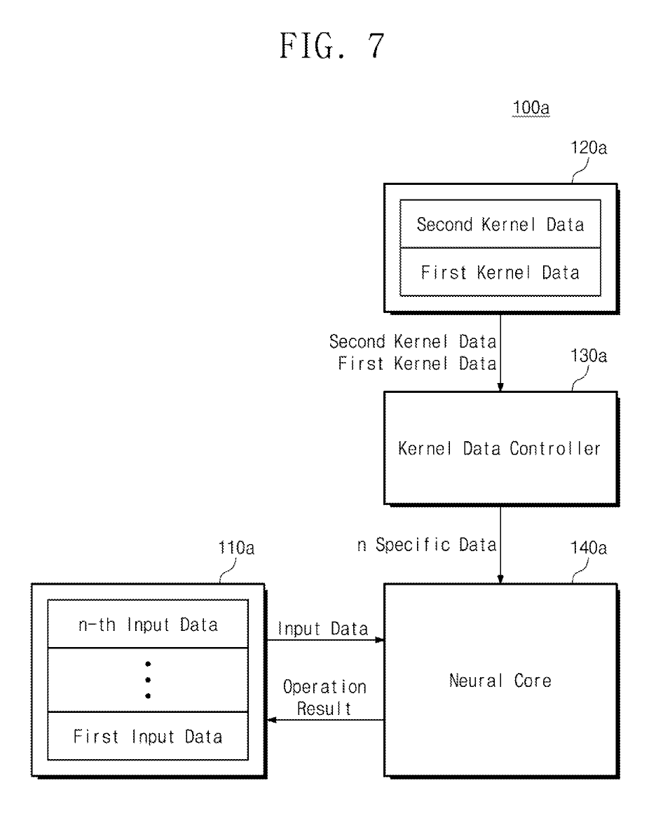

FIG. 8 is a view showing an example of a first kernel data and second data processed by the kernel neural network computing device of FIG. 7. Referring to FIG. 8, the first kernel data and the second kernel data may be in the same 16-bit floating point format as the kernel data of FIG. 4. The description of the first kernel data and the second kernel data in FIG. 8, which are the same as those of the kernel data in FIG. 4, can be omitted.

The kernel data controller 130a may determine whether the first part of the first kernel data matches a predetermined bit string. The first part may include the exponent portion of the first kernel data and the most significant bit of the mantissa portion. That is, the first part may be a bit string composed of 6 bits. When the first part matches a predetermined bit string, the kernel data controller 130a can determine the first kernel data and the second kernel data as compressed kernel data.

When the first kernel data and the second kernel data are determined as compressed kernel data, the kernel data controller 130a can generate specific data based on the second part of the first kernel data and the second kernel data. The second part may include the remaining bits except the most significant bit of the mantissa portion of the first kernel data. That is, the second part may be a bit string composed of 9 bits. The kernel data controller 130a may generate specific data by the number of bits represented by the bits included in the second part and the second kernel data. As shown in FIG. 8, the bits included in the second part and the bits included in the second kernel data may be a total of 25-bits. Therefore, the maximum value that can be represented by the bits included in the second part and the bits included in the second kernel data may be ‘33,554,431’ (i.e., (2 to the power of 25)−1). That is, when the first kernel data and the second kernel data of FIG. 8 are used, a maximum of 33,554,431 kernel data can be compressed.

If the first part of the first kernel data does not match the predetermined bit string, the kernel data controller 130a can determine whether or not the first part (not shown) of the second kernel data matches the predetermined bit string.

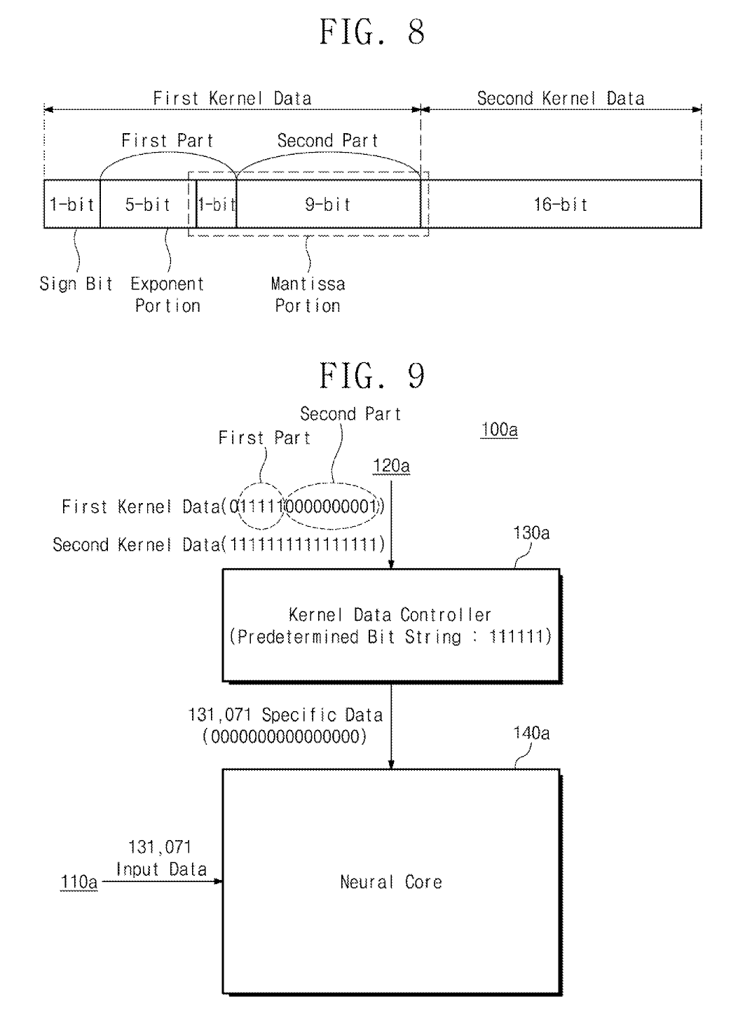

FIG. 9 is a view showing an example of the operation of the neural network computing device of FIG. 7 to process first kernel data and second kernel data. Referring to FIG. 9, the kernel data controller 130a may receive first kernel data and second kernel data from the kernel memory 120a. The bit string of the first kernel data may be ‘0111111000000001’, and the bit string of the second kernel data may be ‘1111111111111111’. The kernel data controller 130a may compare the first part of the kernel data with a predetermined bit string. The first part of the kernel data may be ‘111111’, and the predetermined bit string may be ‘111111’. In this case, since the first part of the first kernel data matches a predetermined bit string, the kernel data controller 130a can determine the first kernel data and the second kernel data as compressed kernel data. When the first kernel data and the second kernel data are determined as compressed kernel data, the kernel data controller 130a may generate specific data by the number of bits represented by the bits of the second part of the first kernel data and the bits of the second kernel data.

Since the second part of the first kernel data is ‘000000001’ and the second kernel data is ‘1111111111111111’, the bits of the second part of the first kernel data and the bits of the second kernel data may be ‘131,071’ (i.e., (2 to the power of 17)−1). Accordingly, the kernel data controller 130a can generate 131,071 specific data. For example, the kernel data controller 130a may generate data representing 131,071 consecutive ‘0’s. The kernel data controller 130 may generate 131,071 16-bits ‘0000000000000000’ as specific data representing ‘0’ to match the number of bits with the kernel data. That is, the kernel data controller 130a may generate 131,071 16-bit specific data.

The kernel data controller 130a may sequentially output 131,071 specific data to the neural core 140a. The neural core 140a receives 131,071 input data from the neural network memory 110a and 131,071 specific data from the kernel data controller 130a. Accordingly, the neural core 140a can perform an operation between the input data 131,071 and the specific data.

As shown in FIG. 9, the predetermined bit string may be ‘111111’. The predetermined bit string can be compared with the first part including the exponent portion of the first kernel data. If the exponent portion of the first kernel data is ‘11111’, the first kernel data may not be infinite or not a number. Thus, a predetermined bit string (i.e., ‘111111’) may represent that the first kernel data is infinite or not a number.

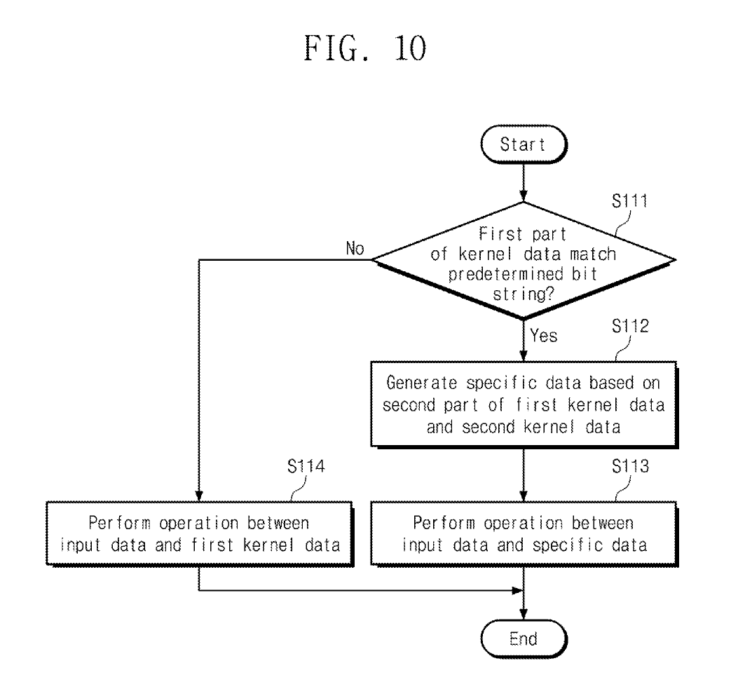

FIG. 10 is a flowchart showing an example of the operation of the neural network computing device of FIG. 7. Referring to FIGS. 7 to 10, in operation S111, the neural network computing device 100a may determine whether the first part of the first kernel data matches a predetermined bit string. As shown in FIG. 8, the first kernel data may be in floating point format, and the first part of the first kernel data may include the exponent portion of the first kernel data and the most significant bit of the mantissa portion of the first kernel data. The predetermined bit string may be a bit string representing that the first kernel data is infinite or is not a number. As shown in FIG. 9, all bits included in the predetermined bit string may be ‘1’.

When the first part of the first kernel data matches the predetermined bit string, in operation S112, the neural network computing device 100a can generate specific data based on the second part of the first kernel data and the second kernel data. The neural network computing device 100a can generate the specific data by the number corresponding to the value represented by the combination of the bit string of the second part and the bit string of the second kernel data. As shown in FIG. 9, the neural network computing device 100a may generate specific data representing ‘0’.

In operation S113, the neural network computing device 100a may perform an operation between input data and specific data. For example, the neural network computing device 100 may perform a multiplication operation between input data and specific data.

If the first part of the kernel data does not match the predetermined bit string, in operation S114, the neural network computing device 100a may perform operations between input data and first kernel data.

As described above, the neural network computing device 100a of FIG. 7 can receive more compressed kernel data than the neural network computing device 100 of FIG. 3 from the outside. Accordingly, the neural network computing device 100a can quickly receive a large amount of kernel data from the outside. Also, the capacity of the received kernel data may be further reduced according to the compressed kernel data. Accordingly, the capacity of the kernel memory 120a storing the kernel data can be further reduced. When the size of the kernel memory 120a is reduced according to the capacity reduction of the kernel memory 120a, the chip area of the neural network computing device 100a may be reduced and the power required to operate the neural network computing device 100a may be reduced.

A neural network computing device according to an embodiment of the present invention can quickly receive a large amount of data by receiving compressed data. Thus, the capacity of the on-chip memory for data storage can be reduced.

In addition, when the size of the on-chip memory is reduced as the capacity of the on-chip memory decreases, the chip area of the neural network computing device may be reduced and the power required for operation may be reduced.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A neural network computing device comprising:
a neural network memory configured to store input data;
a kernel memory configured to store kernel data corresponding to the input data;
a kernel data controller configured to determine whether or not a first part of the kernel data matches a predetermined bit string, and if the first part matches the predetermined bit string, configured to generate a plurality of specific data based on a second part of the kernel data; and
a neural core configured to perform a first operation between one of the plurality of specific data and the input data.

2. The device of claim 1, wherein the kernel data is in a floating point format, and the first part comprises an exponent portion of the kernel data, and the second part comprises a mantissa portion of the kernel data.

3. The device of claim 1, wherein the predetermined bit string represents whether the kernel data is infinite or not a number (NaN).

4. The device of claim 1, wherein the number of the specific data corresponds to a value represented by the second part.

5. The device of claim 1, wherein the specific data represents 0.

6. The device of claim 1, wherein if the first part does not match the predetermined bit string, the kernel data controller transfers the kernel data to the neural core, and the neural core performs a second operation between the input data and the kernel data.

7. The device of claim 6, wherein the first operation and the second operation are multiplication operations.

8. The device of claim 1, wherein the kernel memory stores first kernel data and second kernel data,
wherein when the first part of the first kernel data matches the predetermined bit string, the kernel data controller generates a plurality of specific data based on the second part of the first kernel data and the second kernel data.

9. The device of claim 8, wherein the first and second kernel data are in a floating point format,
wherein the first part of the first kernel data comprises an exponent portion of the first kernel data and a most significant bit of a mantissa portion of the first kernel data,
wherein the second part of the first kernel data comprises remaining bits except the most significant bit of the mantissa portion.

10. The device of claim 8, wherein the number of the specific data corresponds to a value represented by a combination of a bit string of the second part of the first kernel data and a bit string of the second kernel data.

11. A method of operating a neural network computing device including a kernel data controller and a neural core, the method comprising:
determining, by the kernel data controller, whether a first part of kernel data corresponding to input data matches a predetermined bit string;
generating, by the kernel data controller, a plurality of specific data based on a second part of the kernel data when the first part matches the predetermined bit string;
providing, by the kernel data controller, one of the plurality of specific data to the neural core; and
performing, by the neural core, a first operation between the input data and the specific data.

12. The method of claim 11, wherein the kernel data is in a floating point format, and the first part comprises an exponent portion of the kernel data, and the second part comprises a mantissa portion of the kernel data.

13. The method of claim 11, wherein the predetermined bit string represents whether the kernel data is infinite or not a number (NaN).

14. The method of claim 11, wherein the generating of the plurality of specific data comprises generating, by the kernel data controller, the specific data by a number corresponding to a value represented by the second part.

15. The method of claim 11, wherein the specific data represents 0.

16. The method of claim 11, further comprising:
if the first part does not match the predetermined bit string, transferring, by the kernel data controller, the kernel data to the neural core; and
performing, by the neural core, a second operation between the input data and the kernel data.

17. The method of claim 16, wherein the first operation and the second operation are multiplication operations.
